(19) United States
(12) Patent Application Publication
(10) Pub. No.: US 2016/0073264 A1
(43) Pub. Date: Mar. 10, 2016

(54) DISTRIBUTED AND MOBILE VIRTUAL FENCES

(71) Applicant: Alcatel Lucent, Boulogne Billancourt (FR)

(72) Inventors: Marc Van den Broeck, Sint-Katelijne-Waver (BE); Mohamed Feki, Antwerp (BE); Fahim Kawsar, Antwerp (BE); Geert Vanderhulst, Antwerp (BE)

(21) Appl. No.: 14/478,487

(22) Filed: Sep. 5, 2014

(51) Int. Cl. H04W 12/08; H04W 4/02; H04M 1/725; H04W 12/06

(52) U.S. Cl. CPC H04W 12/08; H04W 12/06; H04W 4/021; H04M 1/72533

(57) ABSTRACT

A virtual fence server receives a request to access a service for remote control of a device from user equipment. The virtual fence server authorizes the user equipment to access the service in response to the user equipment being within a virtual fence defined by beacon signals generated by a plurality of beacons. The virtual fence encompasses a plurality of geographically distinct areas.

### CROSS REFERENCE TO RELATED APPLICATIONS

This application is related to U.S. patent application Ser. No. 14/204,071, entitled “ACCESS CONTROL OF GEO-FENCED SERVICES USING CO-LOCATED WITNESSES” and filed on Mar. 11, 2014, the entirety of which is incorporated by reference herein.

### BACKGROUND

1. Field of the Disclosure

The present disclosure relates generally to providing wireless access to services and, more particularly, to controlling access to the services based on a virtual fence.

2. Description of the Related Art

Network technology is being incorporated into a large variety of devices so that these devices can communicate with each other. One application of the growing “Internet of Things” is to allow users to control various household services using their smartphone. For example, the user may be able to control the brightness or color of lights in rooms of their house, control their thermostat, set a burglar or fire alarm, lock or unlock doors, and perform other functions simply by opening the appropriate application on their smartphone. However, unscrupulous users may also be able to hack into the devices in another user's house and assume control of the same devices or services. Usernames and passwords may be used to establish secure communication between an authorized user and their devices or services, but using and maintaining username/password combinations for every device or service can become unwieldy and discourage users from making use of the applications.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for controlling access to services using distributed or mobile virtual fences. The method may include receiving, at a virtual fence server, a request to access a service for remote controlling a device from user equipment. The method may also include authorizing the user equipment to access the service in response to the user equipment being within a virtual fence defined by beacon signals generated by a plurality of beacons. The virtual fence encompasses a plurality of geographically distinct areas.

In some embodiments, a server is provided for controlling access to services using distributed or mobile virtual fences. The server may include one or more processors to receive a request to access a service for remote controlling a device from user equipment. The server may authorize the user equipment to access the service in response to the user equipment being within a virtual fence defined by beacon signals generated by a plurality of beacons. The virtual fence encompasses a plurality of geographically distinct areas

In some embodiments, user equipment is provided for accessing services based on distributed or mobile virtual fences. The user equipment may include a transceiver to transmit a request to access a service for remote controlling a device from the user equipment. The user equipment may receive authorization to access the service in response to the user equipment being within a virtual fence defined by beacon signals generated by a plurality of beacons. The virtual fence encompasses a plurality of geographically distinct areas

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a first example of a wireless communication system according to some embodiments.

FIG. 2 is a diagram of user profiles that store information indicating mapping of user equipment to one or more virtual fences according to some embodiments.

FIG. 3 is a signaling flow for implementing a method for accessing a service from within a virtual fence defined by passive beacons according to some embodiments.

FIG. 4 is a signaling flow for implementing a method for accessing a service from within a virtual fence defined by active beacons according to some embodiments.

FIG. 5 is a block diagram of a second example of a wireless communication system according to some embodiments.

### DETAILED DESCRIPTION

Users may be allowed to access a service for remotely controlling a device via a smartphone application based on the user's presence within a virtual fence that is defined by one or more beacon signals generated by one or more beacons. A virtual fence server may store information identifying the beacons that define the virtual fence in a profile associated with the user. Some embodiments of the profile include fields that store information identifying the virtual fence, one or more geographical locations encompassed by the virtual fence, and one or more beacons that provide beacon signals within the one or more geographical locations. For example, the user may define a virtual fence called “Home” and this virtual fence may include fields that identify different locations such as “Living Room,” “Bedroom,” “Garage,” “Office,” which may or may not be proximate each other or in the same geographic location. Each of these fields may then be associated with one or more beacon identifiers that uniquely identify beacons that are installed in the geographic locations. The user may be authorized to control household services from a smartphone when the smartphone receives a beacon signal from (or transmits and identifying signal to) one of the uniquely identified beacons. In some embodiments, the beacon identifier fields may be dynamic and may be modified by third parties. For example, a user may define a virtual fence called “Commuter Train” and identify the geographic locations encompassed by this virtual fence as “Trains departing Station A for Station B between 8 AM and 9 AM.” The beacons that correspond to the geographic location may change because different wagons (or cars or coaches) may be attached to the train on different days. A third-party may therefore dynamically update the beacon list for this virtual fence based on the third party's knowledge of the beacons installed in the wagons that form the trains.

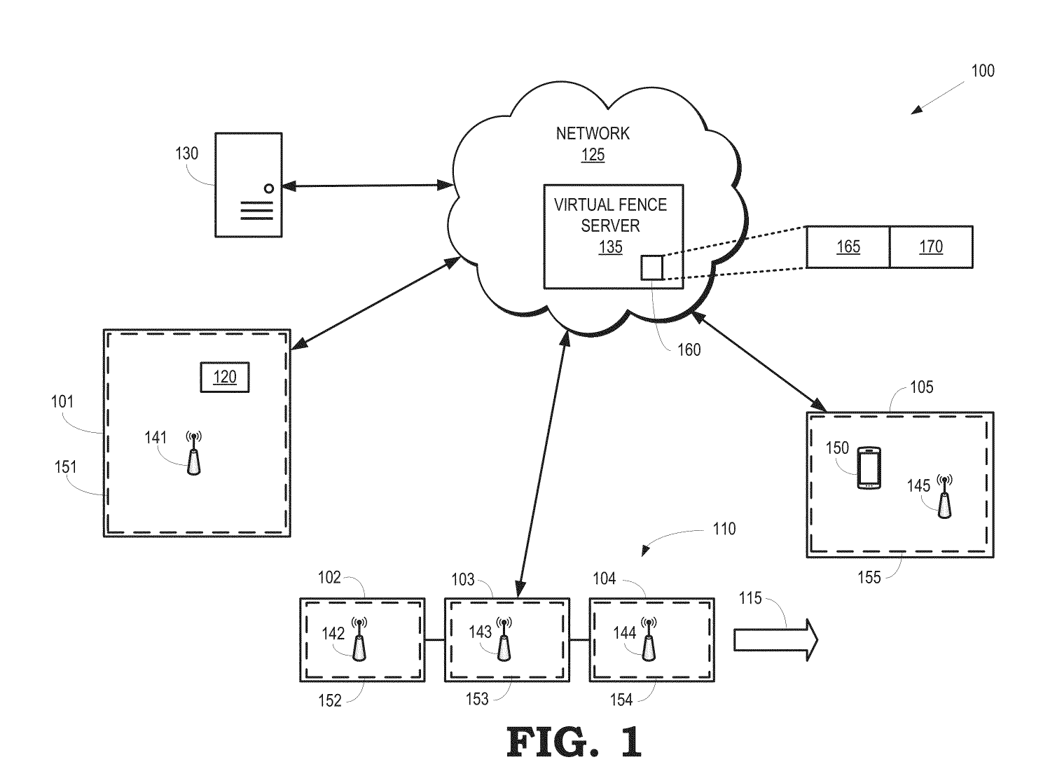

FIG. 1 is a block diagram of an example of a wireless communication system 100 according to some embodiments. The wireless communication system 100 includes a plurality of locations 101, 102, 103, 104, 105, which may be referred to collectively as “the locations 101-105.” The locations 101-105 are non-overlapping (or partially overlapping) and they may therefore be referred to as geographically distinct locations 101-105. A subset of the locations 101-105 may be stationary locations that remain in substantially the same position over time. For example, the location 101 may be a living room in a user's house (and thus also referred to herein as “user's living room 101”) and the location 105 may be the user's office in the user's workplace (and thus also referred to herein as “user's office 105”). Another subset of the locations 101-105 may be non-stationary locations such as moving vehicles that do not remain in substantially the same position over time. For example, the location 102 may be a wagon in a commuter train 110, the location 103 may be another wagon in the commuter train 110, and the location 104 may be another wagon in the commuter train 110. The commuter train 110 may be traveling from a location near the user's living room 101 to a location near the user's office 105, as indicated by the arrow 115. The physical structures that make up some embodiments of the non-stationary locations may also change. For example, the number of wagons in the commuter train 110 may be different on different days or at different times of the day and the specific wagons that form the commuter train 110 may be different on different days or at different times of the day.

The wireless communication system 100 also includes one or more objects 120 that can be controlled remotely by authorized users. The object 120 may be any type of object that is capable of being controlled using communications provided over a wired or wireless network 125. Examples of objects such as the object 120 include a lighting system, a burglar or fire alarm, a thermostat, a locking system to secure windows or doors, a computer, an appliance, or a lawn or garden watering system. Control of the object 120 may be implemented using a service or application provided by an application server 130. The application server 130 may therefore be connected to the object 120 over the network 125 so that the application server 130 may provide instructions to control the operation of the object 120 and receive data or status information from the object 120. For example, the application server 130 may instruct a lighting system to turn on one or more lights, turn off one or more lights, or change the color or brightness provided by one or more lights. For another example, the application server 130 may instruct a thermostat to raise the temperature, lower the temperature, or maintain the temperature within a specified range of temperatures.

Users can communicate with the application server 130 to control operation of the object 120. However, control of the object 120 should only be provided to authorized users and users may only be authorized to control the object 120 if they are within or proximate a set of authorized locations. Some embodiments of the network 125 host a virtual fence server 135 that is used to determine locations of users that are requesting authorization to control operation of the object 120 and provide authorization to users that are within the set of authorized locations are proximate the set of authorized locations.

The wireless communication system 100 uses beacons 141, 142, 143, 144, 145 (collectively referred to as “the beacons 141-145”) to determine whether user equipment 150 is located within corresponding regions 151, 152, 153, 154, 155 (indicated by the dashed boxes and collectively referred to as “the regions 151-155”). A single beacon 141-145 is shown within each corresponding region 151-155 in the interest of clarity. However, some embodiments may include multiple beacons that may be used to define one or more of the regions 151-155. The beacons 141-145 may be configured to transmit or receive signals over the air interface according to any wireless communication protocol and, in some embodiments, the beacons 141-145 may also be configured to transmit or receive signals according to wired communication protocols. For example, the beacons 141-145 may transmit or receive signals according to Bluetooth, Wi-Fi, ZigBee, or other wireless communication standards. The beacons 141-145 may be passive beacons that transmit an identifying signal over the air interface. For example, the beacons 141-145 may transmit a unique identifying number in a message over the air interface. User equipment 150 may receive the identifying signal from one or more of the beacons 141-145 and transmit this information to the virtual fence server 135 to demonstrate that it is within the corresponding region 151-155. The beacons 141-145 may also be active beacons that can be instructed (e.g., by the virtual fence server 135) to listen for an identifying signal transmitted by the user equipment 150. If an active beacon 141-145 detects the identifying signal, the active beacon 141-145 may inform the virtual fence server 135, which may use the information to locate the user equipment 150 within the corresponding region 151-155.

The regions 151-155 define a virtual fence. The user equipment 150 may be authorized to control the object 115 entities within the virtual fence defined by the regions 151-155. The virtual fence server 135 may authorize the user equipment 150 to control the object 120 (e.g., by communicating with the application server 130) in response to the user equipment 150 being located within one of the regions 151-155. Some embodiments of the virtual fence server 135 include a mapping 160 that maps information 165 identifying the user equipment 150 to information 170 that identifies the beacons 141-145 that define the virtual fence around the regions 151-155. Thus, the virtual fence server 135 may use the mapping 160 to authorize the user equipment 150 to control the object 115 if the virtual fence server 135 receives signals or messages from the user equipment 150 or one or more of the beacons 141-145 indicating that the user equipment 150 is within one or more of the regions 151-155, as discussed herein.

The beacons 141-145 that define a virtual fence may change. For example, a user may define the virtual fence using words or phrases such as “Living Room,” “Train,” and “Office” to refer to the locations 101-105. The user may be aware of the identity of some of the beacons 141-145 that define the regions 151-155 associated with some of the locations 101-105. For example, the user may be aware of the identity of the beacon 141 used to define the region 151 associated with the user's living room 101 and the beacon 145 used to define the region 155 associated with the user's office. The user may therefore be able to configure a profile to define the mapping 160 for the portion of the virtual fence associated with the “Living Room” and the “Office.” The identifying information transmitted by the beacons 141, 145 in the stationary regions 151, 155 may remain the same over the lifetime of the beacons 141, 145. However, the user can also change the mapping 160 response to identities of the corresponding beacons changing, e.g., in response to beacons being added or removed from the regions 151, 155.

In some embodiments, the user may not be aware of the identity of other beacons 141-145 that define other portions of the virtual fence. For example, the beacons 142-144 that define the portion of the virtual fence associated with the “Train” may change because the wagons that form the commuter train 110 may change from day-to-day, trip-to-trip, or over the course of a trip as cars are added to the commuter train 110 or removed from the commuter train 110. The user may therefore indicate that the wagons of the commuter train 110 should be included as a portion of the virtual fence associated with the user, but the user may rely on a third-party to define the mapping 160 of the user equipment 150 to the beacons 142-144 associated with the portion of the virtual fence that encompasses the wagons of the commuter train 110. In some embodiments, the third-party may dynamically update the mapping 160 for the virtual fence based on the third party's knowledge of the beacons installed in the wagons that form the commuter train 110. For example, the third-party may use the identities of the different wagons that make up the commuter train 110 on different days to identify the beacons 142-144 that will be in the different wagons on the different days. The third-party may then update or modify the mapping 160 to reflect the changing identities of the beacons in the wagons.

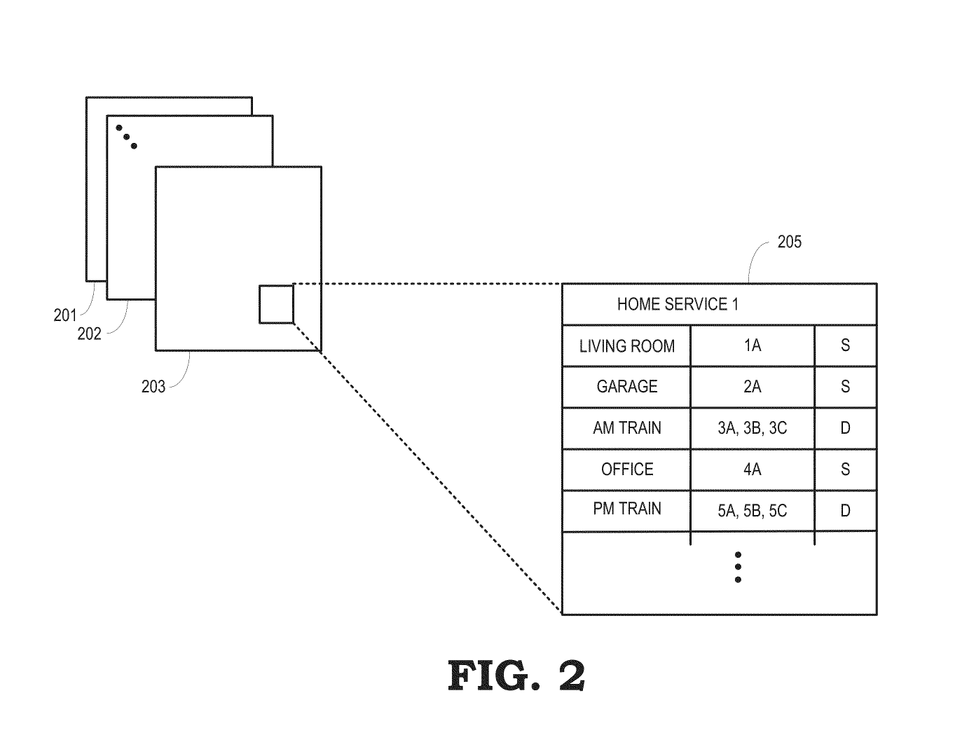

FIG. 2 is a diagram of user profiles 201, 202, 203 that store information indicating mapping of user equipment to one or more virtual fences according to some embodiments. The user profiles 201, 202, 203 may be referred to collectively as the “user profiles 201-203”. In some embodiments, the user profiles 201-203 may represent data structures that can be stored in a memory location such as memory in (or associated with) the virtual fence server 135 shown in FIG. 1. The user profiles 201-203 may be used to define a mapping between user equipment and virtual fences such as the mapping 160 shown in FIG. 1. Some embodiments of the user profiles 201-203 include one or more tables such as table 205 in profile 203. The tables include information defining a virtual fence that is associated with one or more services. The services may be provided by an application server such as the application server 130 shown in FIG. 1. For example, the table 205 may include information defining a virtual fence associated with Home Service 1. The virtual fence server may use the information in the table 205 to authorize the user associated with the user profile 203 to control Home Service 1 from within the virtual fence defined by the table 205.

The virtual fence defined by the table 205 includes a plurality of places including “Living Room,” “Garage,” “AM Train,” “Office,” and “PM Train.” A user may add or remove places from the table 205, e.g., by using user equipment (or another network-connected device) to access and modify the table 205. By defining the virtual fence in the table 205, a user may be able to access Home Service 1 while sitting in the Living Room, cleaning the Garage, taking the AM Train to work, working in the Office, and taking the PM train back home.

The table 205 includes fields that store information indicating identities of one or more beacons that define portions of the virtual fence associated with corresponding places. For example, a beacon identified by the identifier “1A” may be used to identify user equipment that are within a portion of the virtual fence corresponding to the Living Room, a beacon identified by the identifier “2A” may be used to identify user equipment that are within a portion of the virtual fence corresponding to the Garage, beacons identified by the identifiers “3A, 3B, 3C” may be used to identify user equipment that are within a portion of the virtual fence corresponding to one or more wagons of the AM Train, a beacon identified by the identifier “4A” may be used to identify user equipment that are within a portion of the virtual fence corresponding to the Office, and beacons identified by the identifiers “5A, 5B, 5C” may be used to identify user equipment that are within a portion of the virtual fence corresponding to one or more wagons of the PM Train.

The table 205 includes fields that store information indicating whether the beacon identifiers associated with the corresponding place are static (“S”) or dynamic (“D”). Beacon identifiers that are associated with static places may remain fixed over long periods of time. For example, the beacon identifier in the Living Room may remain the same for months or years because the user may not install or replace the beacon for a long period of time. Static beacon identifiers may be changed response to a request by the user to modify the beacon identifier. Beacon identifiers associated with dynamic places may be expected to change frequently. For example, the beacons in the wagons of the AM Train may change every morning because different wagons may be added or removed from the train. Consequently, the beacon identifiers may be modified or updated in response to events associated with the beacons. Requests to verify that user equipment is within a virtual fence defined by the table 205. For example, a server such as the virtual fence server 135 shown in FIG. 1 may send one or more requests to third parties to update or modify beacon identifiers in the table 205 at specified times of time intervals, e.g., the server may send a request to update the AM Train beacon list prior to the train departing in the morning. For another example, the server may send requests for beacon list updates in response to a request from a user to access a service.

The table 205 may include other information that can be used to define the virtual fence. In some embodiments, places in the table 205 may be associated with time intervals that indicate when the place should be included in a virtual fence. For example, the AM Train entry in the table 205 may be associated with a time interval from 7 AM to 9 AM on weekday mornings so that the virtual fence only includes the AM Train during the specified time interval. The time intervals can be configured by the user or a third party. For example, a third-party may use the scheduled departure times of morning commuter trains to define when the AM Train is a part of the virtual fence.

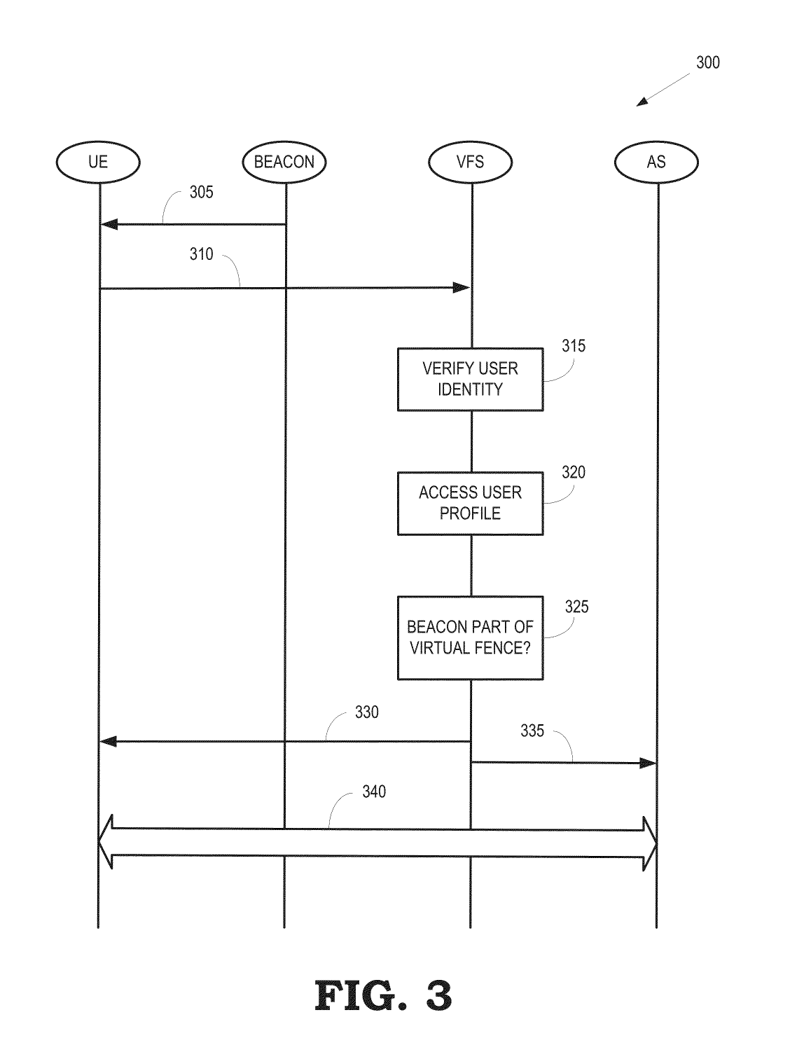

FIG. 3 is a signaling flow for implementing a method 300 for accessing a service from within a virtual fence according defined by passive beacons to some embodiments. The method 300 may be implemented in some embodiments of the wireless communication system 100 shown in FIG. 1. User equipment (UE) monitor signals transmitted or broadcast (at 305) by one or more beacons that may be used to define the virtual fence is associated with geographically distinct regions. The beacons implemented in the illustrated embodiment of method 300 are passive beacons that broadcast a signal including information identifying the beacon, such as a unique number assigned to the beacon. If the UE wants to access a service, such as a service for remotely controlling an object in the user's home, the UE generates a message including the information identifying the beacon and transmits this message to a virtual fence server (VFS) at 310. The message also includes information identifying the UE, such as an international mobile subscriber identity (IMSI).

At block 315, the VFS attempts to verify the identity of the UE based on the information transmitted in the message. The method 300 may end if the VFS fails to verify the identity of the UE. If the VFS verifies the identity of the UE based on the information transmitted in the message, the VFS accesses a profile associated with the user at block 320. For example, the VFS may access a user profile such as one of the user profiles 201-203 shown in FIG. 2. At block 325, the VFS determines whether the beacon (or beacons) identified in the message transmitted by the UE are part of a virtual fence defined by a mapping in the user profile such as the mapping 160 shown in FIG. 1 or the mapping indicated by the table 205 shown in FIG. 2. The method 300 may end if the VFS determines that the beacon (or beacons) is not part of a virtual fence defined by the mapping in the user profile so that the UE is not authorized to access the service from its current location.

The VFS may authorize the UE to access the service in response to the VFS determining that the beacon (or beacons) is a part of a virtual fence defined by the mapping in the user profile. In response to authorizing the UE to access the service, the VFS transmits (at 330) a message to the UE instructing the UE to establish a connection to an application server (AS) to access the requested service. The VFS also transmits (at 335) a message to the AS informing the AS that the UE has been authorized to access the requested service. The messages transmitted at 330 and at 335 may be transmitted in any order or concurrently. The UE and the AS may then establish (at 340) a connection and exchange signaling or messages to support the requested service. For example, the UE may provide instructions that allow the AS to control objects in the user's home based on the provided instructions, as discussed herein.

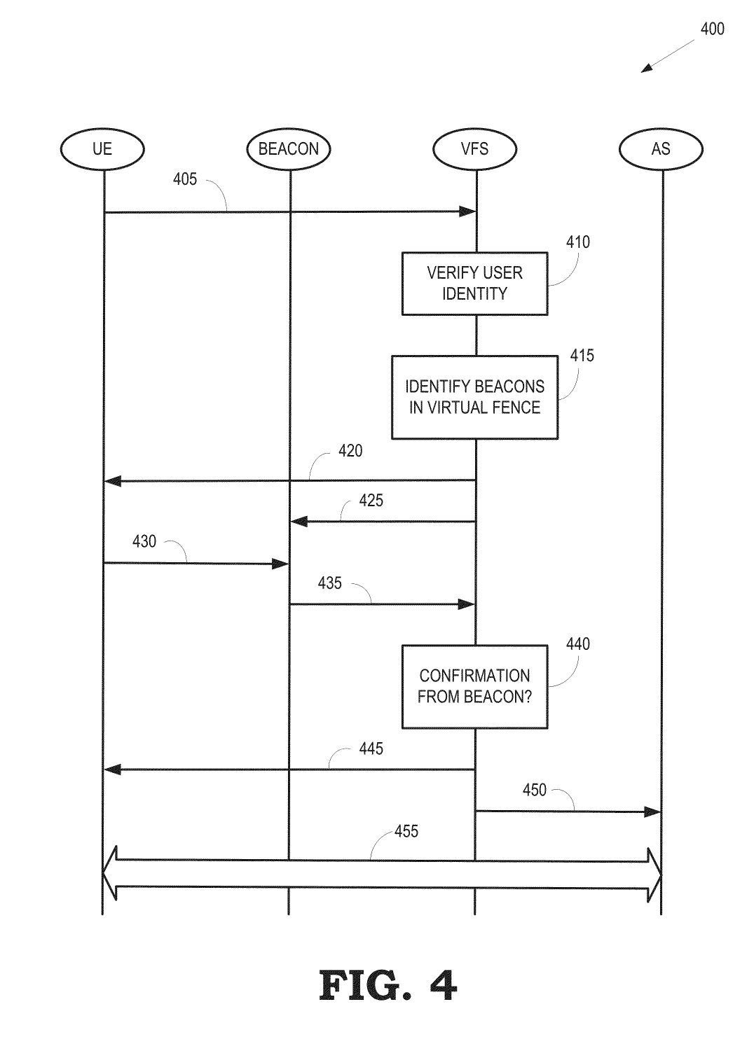

FIG. 4 is a signaling flow for implementing a method 400 for accessing a service from within a virtual fence defined by active beacons according to some embodiments. The method 400 may be implemented in some embodiments of the wireless communication system 100 shown in FIG. 1. The beacons implemented in the illustrated embodiment of method 400 are active beacons that can exchange messages with user equipment (UE) and a virtual fence server (VFS) and can perform actions in response to messages received from the UE or the VFS. If the UE wants to access a service, such as a service for remotely controlling an object in the user's home, the UE generates a message including information identifying the UE, such as an international mobile subscriber identity (IMSI), and transmits this message to the VFS at 405. At block 410, the VFS attempts to verify the identity of the UE based on the information transmitted in the message. The method 400 may end if the VFS fails to verify the identity of the UE. In some embodiments, the service request from the UE and the information identifying the UE may be sent in different messages. For example, the VFS may request the information identifying the UE in response to the UE requesting access to the service.

If the VFS verifies the identity of the UE based on the information transmitted in the message, the VFS accesses a profile associated with the user, such as one of the user profiles 201-203 shown in FIG. 2, and identifies (at 415) one or more beacons that are part of a virtual fence defined by a mapping in the user profile such as the mapping 160 shown in FIG. 1 or the mapping 205 shown in FIG. 2. The VFS attempts to verify the presence of the UE in one or more regions associated with the virtual fence by transmitting (at 420) a message to the UE that instructs the UE to transmit a message to the beacon (or beacons) defined in the mapping. Some embodiments of the message transmitted by the VFS may include a random number or a nonce that should be included in the message transmitted by the UE to the beacon (or beacons). The VFS also transmits (at 425) a message to the beacon (or beacons) that instructs the beacon (or beacons) to listen for messages transmitted by the UE. Some embodiments of the message may include information identifying the UE or the random number or the nonce that is to be transmitted by the UE.

The UE transmits (at 430) a message to the beacon (or beacons), which may optionally include information identifying the UE or the random number or the nonce provided by the VFS. In response to receiving the message, the beacon (or beacons) may transmit (at 435) a message to the VFS confirming receipt of the message from the UE. Some embodiments of the beacon (or beacons) may confirm receipt of the message based on information identifying the UE or the random number or the nonce provided by the VFS. For example, the beacon (or beacons) may confirm receipt of the message if the information identifying the UE, the random number, or the nonce received in the message from the UE matches the information identifying the UE, the random number, or the nonce provided by the VFS.

The VFS may authorize the UE to access the requested service in response to receiving (at 440) confirmation that the beacon (or beacons) received the expected message from the UE. In response to authorizing the UE to access the service, the VFS transmits (at 445) a message to the UE instructing the UE to establish a connection to an application server (AS) to access the requested service. The VFS also transmits (at 450) a message to the AS informing the AS that the UE has been authorized to access the requested service. The messages transmitted at 445 and at 450 may be transmitted in any order or concurrently. The UE and the AS may then establish (at 455) a connection and exchange signaling or messages to support the requested service. For example, the UE may provide instructions that allow the AS to control objects in the user's home based on the provided instructions, as discussed herein.

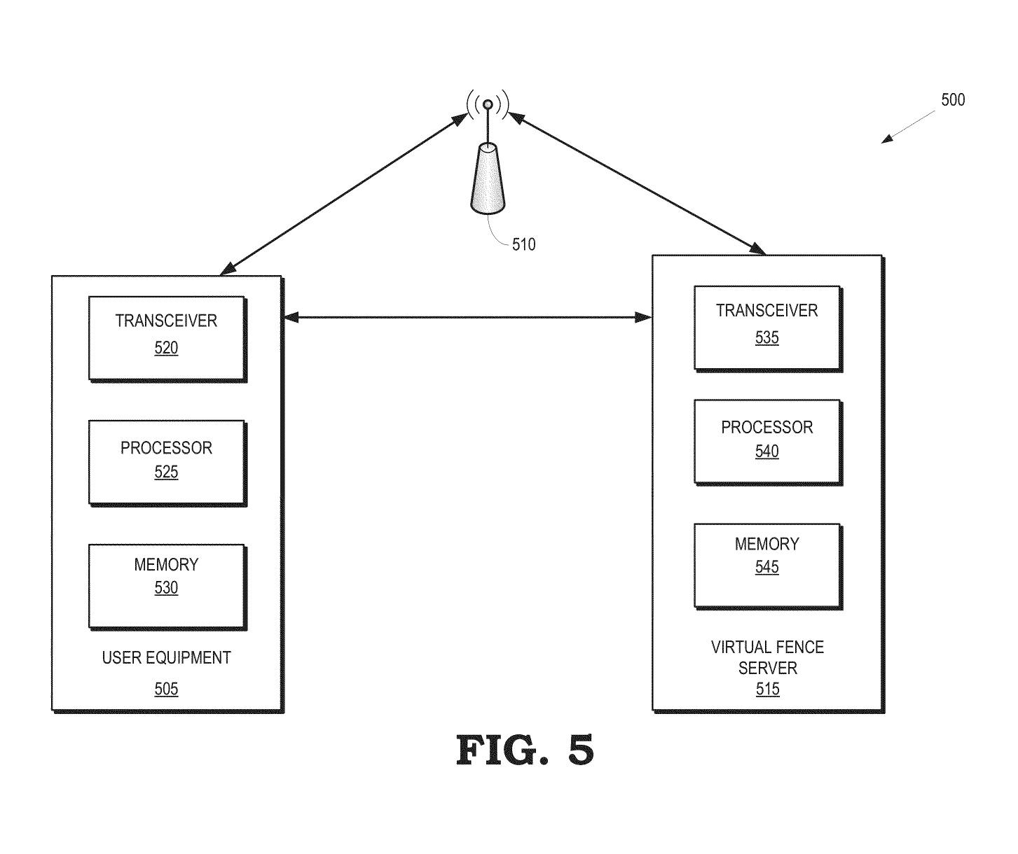

FIG. 5 is a block diagram of a second example of a wireless communication system 500 according to some embodiments. The wireless communication system 500 includes user equipment 505, a beacon 510, and a virtual fence server 515. In some embodiments, the user equipment 505, the beacon 510, and the virtual fence server 515 may correspond to the user equipment 150, one or more of the beacons 141-145, or the virtual fence server 135 shown in FIG. 1.

The user equipment 505 includes a transceiver 520 for transmitting or receiving messages, such as messages transmitted or received by the beacon 510 or the virtual fence server 515. The transceiver 520 may therefore support wired or wireless communication. The user equipment 505 also includes a processor 525 and a memory 530. The processor 525 may be used to execute instructions stored in the memory 530 and to store information in the memory 530 such as the results of the executed instructions. Some embodiments of the transceiver 520, the processor 525, or the memory 530 may be used to implement embodiments of the techniques described herein including the method 300 shown in FIG. 3 or the method 400 shown in FIG. 4.

The virtual fence server 515 includes a transceiver 535 for transmitting or receiving messages, such as messages transmitted or received by the user equipment 505 or the beacon 510. The transceiver 535 may therefore support wired or wireless communication. The virtual fence server 515 also includes a processor 540 and a memory 545. The processor 540 may be used to execute instructions stored in the memory 545 and to store information in the memory 545 such as the results of the executed instructions. Some embodiments of the transceiver 535, the processor 540, or the memory 545 may be used to implement embodiments of the techniques described herein including the method 300 shown in FIG. 3 or the method 400 shown in FIG. 4. In some embodiments, the beacon 510 may also include one or more transceivers, processes, or memories to perform embodiments of the techniques described herein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a virtual fence server, a request to access a service for remote control of a device from user equipment; and
authorizing the user equipment to access the service in response to the user equipment being within a virtual fence defined by beacon signals generated by a plurality of beacons, wherein the virtual fence encompasses a plurality of geographically distinct areas.

2. The method of claim 1, wherein the plurality of geographically distinct areas comprises a plurality of rooms in different buildings.

3. The method of claim 1, wherein the plurality of geographically distinct areas comprises at least one moving vehicle.

4. The method of claim 1, wherein authorizing the user equipment to access the server comprises identifying the plurality of beacons based on a user profile stored by the virtual fence server.

5. The method of claim 4, further comprising:
modifying the plurality of beacons that define the virtual fence in response to a request from the user equipment or a third party.

6. The method of claim 1, wherein receiving the request to access the service comprises receiving a request comprising information identifying at least one of the plurality of beacons, and wherein authorizing the user equipment to access the service comprises authorizing the user equipment to access the service in response to the at least one of the plurality of beacons defining a portion of the virtual fence.

7. The method of claim 1, wherein receiving the request to access the service comprises receiving a request comprising information identifying the user equipment, and wherein authorizing the user equipment to access the service comprises identifying the plurality of beacons using the information identifying the user equipment.

8. The method of claim 7, further comprising:
transmitting a message instructing the user equipment to transmit a signal to at least one of the plurality of beacons; and
transmitting a message instructing the at least one of the plurality of beacons to listen for the signal transmitted by the user equipment.

9. The method of claim 8, wherein authorizing the user equipment to access the service comprises authorizing the user equipment to access the service in response to a message indicating that the at least one of the plurality of beacons received the signal transmitted by the user equipment.

10. The method of claim 1, further comprising:
transmitting a confirmation to the user equipment and a confirmation to an application server that provides the service in response to authorizing the user equipment to access the service.

11. A server, comprising:
at least one processor to receive a request to access a service for remote control of a device from user equipment and authorize the user equipment to access the service in response to the user equipment being within a virtual fence defined by beacon signals generated by a plurality of beacons, wherein the virtual fence encompasses a plurality of geographically distinct areas.

12. The server of claim 11, wherein the at least one processor is to:
identify the plurality of beacons in a user profile stored by the server; and.
modify at least one beacon in the plurality of beacons that define the virtual fence in response to a request from the user equipment or a third party.

13. The server of claim 11, wherein the at least one processor is to receive a request comprising information identifying at least one of the plurality of beacons and authorize the user equipment to access the service in response to the at least one of the plurality of beacons defining a portion of the virtual fence.

14. The server of claim 11, wherein the at least one processor is to receive a request comprising information identifying the user equipment, identify the plurality of beacons using the information identifying the user equipment, transmit a message instructing the user equipment to transmit a signal to at least one of the plurality of beacons, and transmit a message instructing the at least one of the plurality of beacons to listen for the signal transmitted by the user equipment.

15. The server of claim 14, wherein the at least one processor is to authorize the user equipment to access the service in response to a message indicating that the at least one of the plurality of beacons received the signal transmitted by the user equipment.

16. The server of claim 11, wherein the at least one processor is to transmit a confirmation to the user equipment and a confirmation to an application server that provides the service in response to authorizing the user equipment to access the service.

17. User equipment, comprising:
a transceiver to transmit a request to access a service for remote control of a device from the user equipment and receive authorization to access the service in response to the user equipment being within a virtual fence defined by beacon signals generated by a plurality of beacons, wherein the virtual fence encompasses a plurality of geographically distinct areas.

18. The user equipment of claim 17, wherein the transceiver is to transmit a request comprising information identifying at least one of the plurality of beacons and receive authorization to access the service in response to the at least one of the plurality of beacons defining a portion of the virtual fence.

19. The user equipment of claim 17, wherein the transceiver is to transmit a signal to at least one of the plurality of beacons indicated in a message received from a virtual fence server and receive authorization to access the service in response to the virtual fence server receiving confirmation that the at least one of the plurality of beacons received the signal.

20. The user equipment of claim 17, further comprising:
at least one processor to access the service in response to receiving authorization.
